(19) United States
(12) Patent Application Publication
(10) Pub. No.: US 2026/0031467 A1
(43) Pub. Date: Jan. 29, 2026

(54) BATTERY WIRING MODULE

(71) Applicant: SUMITOMO WIRING SYSTEMS, LTD., Mie (JP)

(72) Inventor: Hiroshi SATO, Mie (JP)

(21) Appl. No.: 18/995,147

(22) PCT Filed: Jul. 13, 2023
(86) PCT No.: PCT/JP2023/025819

§ 371 Date: Jan. 16, 2025

(30) Foreign Application Priority Data
Aug. 1, 2022 (JP) 2022-122701

(51) Int. Cl. H01M 50/298; H01M 50/503; H01M 50/507

(52) U.S. Cl. CPC H01M 50/298; H01M 50/503; H01M 50/507

(57) ABSTRACT

A battery wiring module includes a case (22) having a wire housing part (31), and a cover (25) having a lid (70) covering the wire housing part (31). The cover (25) has a first displacement restricting part (71) extending from the lid (70). The first displacement restricting part (71) restricts the displacement of an electric wire (21) in a direction approaching the lid (70).

### TECHNICAL FIELD

The present disclosure relates to a battery wiring module.

### BACKGROUND

As disclosed in Patent Document 1, for example, a battery wiring module is attached to a high-voltage battery that is mounted as a travelling power source in vehicles such as electric vehicles and hybrid vehicles. The battery wiring module includes electric wires that are electrically connected to a battery, a case that has a wire housing part for housing the electric wires, and a cover that covers the wire housing part.

### PRIOR ART DOCUMENT

### Patent Document

Patent Document 1: JP 2021-190156 A

### SUMMARY OF THE INVENTION

### Problems to be Solved

The present inventor has been studying how to restrict the position of each electric wire in a battery wiring module such as the above.

The present disclosure aims to provide a battery wiring module capable of restricting the position of each electric wire.

### Means to Solve the Problem

The battery wiring module of the present disclosure is a battery wiring module that is attachable to a battery, the battery wiring module including: an electric wire to be electrically connected to the battery; a case having a wire housing part housing the electric wire; and a cover having a lid covering the wire housing part, wherein the cover has a displacement restricting part extending from the lid, and the displacement restricting part restricts displacement of the electric wire in a direction approaching the lid.

### Effect of the Invention

The battery wiring module of the present disclosure exhibits the effect of restricting the position of each electric wire.

### BRIEF DESCRIPTION OF THE DRAWINGS

FIG. 1 is a schematic plan view of a battery wiring module of an embodiment.

FIG. 2 is a perspective view of a portion of the battery wiring module of the same embodiment.

FIG. 3 is an exploded perspective view of a portion of the battery wiring module of the same embodiment.

FIG. 4 is a plan view of a portion of a case of the battery wiring module of the same embodiment.

FIG. 5 is a 5-5 cross-sectional view of FIG. 4.

FIG. 6 schematically shows how the cover of the battery wiring module of the same embodiment is fitted.

FIG. 7 is an exploded perspective view of a portion of the battery wiring module of the same embodiment.

FIG. 8 schematically shows how the cover of the battery wiring module of the same embodiment is fitted.

### DETAILED DESCRIPTION TO EXECUTE THE INVENTION

### [Description of Embodiments of Present Disclosure]

Firstly, modes for carrying out the present disclosure are listed and described.

[1] The battery wiring module of the present disclosure is a battery wiring module that is attachable to a battery, the battery wiring module including: an electric wire to be electrically connected to the battery; a case having a wire housing part housing the electric wire; and a cover having a lid covering the wire housing part, wherein the cover has a displacement restricting part extending from the lid, and the displacement restricting part restricts displacement of the electric wire in a direction approaching the lid.

According to this configuration, the electric wire can be housed in the wire housing part while restricting the position of the electric wire with the displacement restricting part.

[2] In the above item [1], the wire housing part may have a slit from which the electric wire is led out, and the displacement restricting part may be configured to block a portion of the slit.

According to this configuration, the displacement restricting part can restrict the position of the electric wire near the slit from which the electric wire is led out.

[3] In the above item [2], the case may have an engagement part to be engaged with an electrical component to be attached to the case, the engagement part may be located outward of the wire housing part at a position corresponding to the slit, and as viewed in a direction in which the engagement part and the slit face each other, a leading end of the displacement restricting part may be located at a position farther from the lid than the engagement part.

According to this configuration, the leading end of the displacement restricting part can restrict the position of the electric wire to a position farther from the lid than the engagement part. This can suppress interference between the electric wire and the electrical component engaging with the engagement part.

[4] In the above item [2] or [3], the wire housing part may have: a bottom wall; and a first side wall and a second side wall that extend from the bottom wall and face each other, the first side wall and the second side wall may each have an open end that is an end on an opposite side to the bottom wall, and the lid covers the open end side of the wire housing part, and the slit may extend from the open end to an end connected to the bottom wall in the first side wall.

According to this configuration, the displacement restricting part can restrict the position of the electric wire near the slit provided in the first side wall of the wire housing part. [5] In the above item [4], the cover may have an abutting part abutting against the open end of the first side wall.

According to this configuration, the abutting part of the cover abuts against the open end of the first side wall, thereby preventing the cover from further approaching the bottom wall. This can prevent the cover from being pushed to the bottom wall side and the electric wire from being sandwiched by the displacement restricting part and the bottom wall.

[6] In the above item [5], the abutting part may include a first abutting part and a second abutting part that are located on respective sides of the displacement restricting part.

According to this configuration, the first and second abutting parts of the cover abut against the open end of the first side wall on respective sides of the displacement restricting part. Thus, the first and second abutting parts can preferably prevent the cover from being pushed to make the displacement restricting part approach the bottom wall.

[7] In any of the above items [4] to [6], the displacement restricting part may have an insertion part inserted into the slit.

According to this configuration, the displacement restricting part, including the insertion part, can be configured so as not to be located inside the wire housing part. This can contribute to securing space within the wire housing part.

[8] In any of the above items [4] to [7], the slit may have an inclined part whose width increases toward the open end of the first side wall.

According to this configuration, the inclined part allows the electric wire to be easily placed into the slit. As a result, the fittability of the electric wire to the case can be improved.

[9] In the above item [8], the displacement restricting part may have an inner wall located on an inner side of the wire housing part, and the inner wall may be located at a position overlapping the inclined part as viewed from a direction in which the first side wall and the second side wall face each other.

According to this configuration, the inner wall can prevent the electric wire from being sandwiched by the inclined part and the displacement restricting part.

[10] In the above item [8], the slit having the inclined part may be one of a plurality of slits provided in the case and arranged along a lengthwise direction of the wire housing part, the displacement restricting part may be one of a plurality of displacement restricting parts provided in the cover in correspondence with the respective slits, the wire housing part may have a wire lead-out part at an end in the lengthwise direction, the electric wire may be one of a plurality of electric wires, one end of each of the plurality of electric wires may be individually led out from a corresponding one of the plurality of slits, and another end of each of the electric wires may be collectively led out from the wire lead-out part.

According to this configuration, each slit having the inclined part can improve the fittability of the plurality of electric wires. In addition, since a plurality of displacement restricting parts are provided in correspondence with the respective slits, the displacement restricting parts can restrict the positions of the electric wires in the slits.

[11] In the above item [10], the plurality of displacement restricting parts may include a first displacement restricting part and a second displacement restricting part, the first displacement restricting part may have an insertion part inserted into a corresponding one of the plurality of slits, the second displacement restricting part may have an inner wall located on an inner side of the wire housing part, the inner wall may be located at a position overlapping the inclined part as viewed from a direction in which the first side wall and the second side wall face each other, the first displacement restricting part may not have the inner wall, and the first displacement restricting part may be provided in correspondence with a slit closest to the wire lead-out part among the plurality of slits.

According to this configuration, in the slit in which the second displacement restricting part is disposed, the inner wall can prevent the electric wire from being sandwiched by the inclined part and the displacement restricting part. Further, the first displacement restricting part, which does not have the inner wall, is provided in correspondence with the slit that is closest to the wire lead-out part. Of the plurality of electric wires, the electric wire that is led out from the slit closest to the wire lead-out part is disposed close to the bottom wall, so that the electric wire is less likely to rise in a direction away from the bottom wall in this slit. Accordingly, the configuration in which the first displacement restricting part corresponding to this slit does not have the inner wall contributes to securing space within the wire housing part.

[12] In the above item [11], the second displacement restricting part may be provided in correspondence with a slit farthest from the wire lead-out part among the plurality of slits.

According to this configuration, of the plurality of electric wires, the electric wire that is led out from the slit farthest from the wire lead-out part is disposed away from the bottom wall of the wire housing part, so that the electric wire is likely to rise in a direction away from the bottom wall in this slit. Accordingly, this slit tends to have a higher risk that the electric wire will be sandwiched by the inclined part and the displacement restricting part. Here, since the second displacement restricting part corresponding to this slit has the inner wall, the inner wall can effectively prevent the electric wire from being sandwiched by the inclined part and the displacement restricting part.

[13] In the above item [10] the plurality of displacement restricting parts may each have an inner wall located on an inner side of the wire housing part, and the inner wall may be located at a position overlapping the inclined part as viewed from a direction in which the first side wall and the second side wall face each other.

According to this configuration, in each slit, the inner wall can prevent the electric wire from being sandwiched by the inclined part and the displacement restricting part.

### DETAILS OF EMBODIMENTS OF THE PRESENT DISCLOSURE

Specific examples of the battery wiring module of the present disclosure are described below with reference to the drawings. The drawings may partially exaggerate or simplify configurations for convenience of description. The dimensional ratio of each part may differ between the drawings. Note that the term “opposing/facing” as used herein means that surfaces or members are at positions directly facing each other, and includes not only the case of being at positions entirely facing each other but also the case of being at positions partially facing each other. Further, the term “opposing/facing” as used herein includes both the case where another member is interposed between two portions and the case where nothing is interposed between two portions.

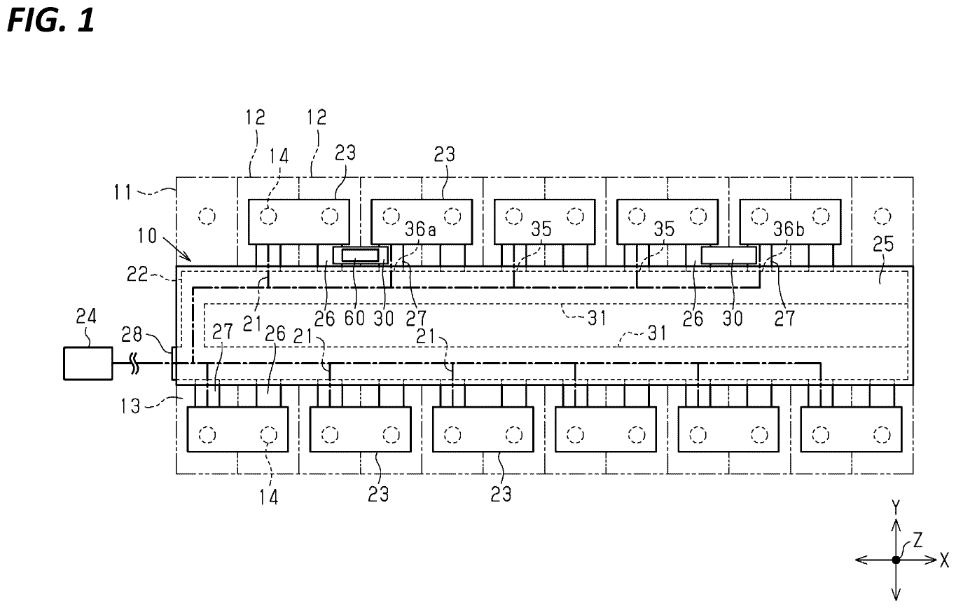

As shown in FIG. 1, a battery wiring module 10 of the present embodiment is configured, for example, to be attached to a battery 11 mounted in an electric vehicle, a hybrid vehicle, or the like. The battery 11 is, for example, a secondary battery. The battery 11 supplies electric power to a travel motor of a vehicle (not shown). Further, the battery 11 receives the supply of electric power from the travel motor and a power-generating motor in accordance with the state of charge and the driving state of the vehicle.

The battery 11 includes a plurality of battery cells 12. The battery 11 has, for example, a substantially rectangular-parallelepiped shape with the plurality of battery cells 12 arranged in rows in one direction. In the following description, the “X-direction” refers to the direction in which the battery cells 12 are arranged, and the “Y-direction” refers to the direction perpendicular to the X-direction. The “Z-direction”, which is orthogonal to the X-direction and the Y-direction, refers to the up-down direction. The term “above/upward/upper side” refers to the side from which the battery wiring module 10 is attached to the battery 11. That is, the battery 11 has a module attachment surface 13, which is an upper surface to which the battery wiring module 10 is attached.

Each battery cell 12 has two battery terminals 14. One of the two battery terminals 14 is a positive terminal, and the other one is a negative terminal. When the battery cells 12 are arranged in the X-direction, the two battery terminals 14 are arranged along the Y-direction on the upper surface of the battery cells 12.

### (Configuration of Battery Wiring Module 10)

The battery wiring module 10 includes a plurality of electric wires 21 that are electrically connected to the battery 11, and a case 22 for housing the electric wires 21. The battery wiring module 10 also includes a plurality of busbars 23, which are supported by the case 22, for example. The busbars 23 are located on both sides in the Y-direction of the case 22, and are arranged side by side along the X-direction. Each busbar 23 connects battery terminals 14 that are adjacent to each other in the X-direction. The busbars 23 are connected to the battery terminals 14 by welding, for example. Each busbar 23 is electrically connected to a corresponding electric wire 21. Each electric wire 21 is, for example, a detection wire for detecting the voltage of the corresponding busbar 23. Each electric wire 21 is connected to a connector 24 for connecting to a detection device (not shown). The battery wiring module 10 also includes a cover 25 that covers the upper side of the case 22.

### (Configuration of Case 22)

The case 22 is made of an insulating material, such as synthetic resin. The case 22 has first busbar holders 26 and second busbar holders 27. The first busbar holders 26 have a shape different from the second busbar holders 27. A plurality of first busbar holders 26 and a plurality of second busbar holders 27 are arranged alternately in the X-direction. The first busbar holders 26 and the second busbar holders 27 form two rows in correspondence with two rows of the busbars 23 that are arranged in the X-direction. A pair of a first busbar holder 26 and a second busbar holder 27 that are adjacent to each other in the X-direction hold one busbar 23. Each busbar 23 spans between the first busbar holder 26 and the second busbar holder 27 that are adjacent to each other in the X-direction.

The case 22 has sensor housing parts 30. For example, a plurality of sensor housing parts 30 are provided. At least one of the plurality of sensor housing parts 30 houses a temperature sensor 60 for detecting the temperature of the battery 11.

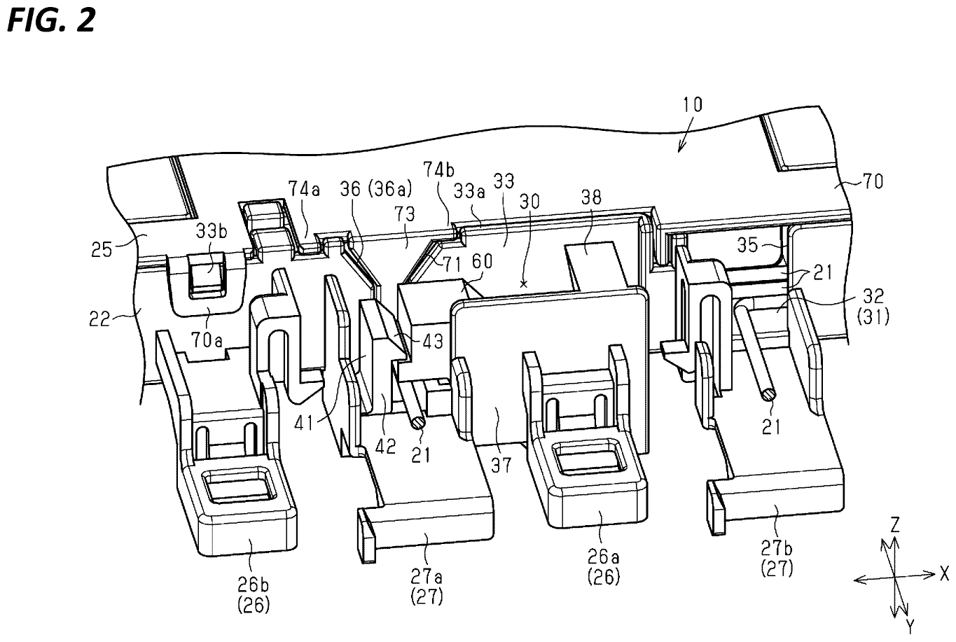

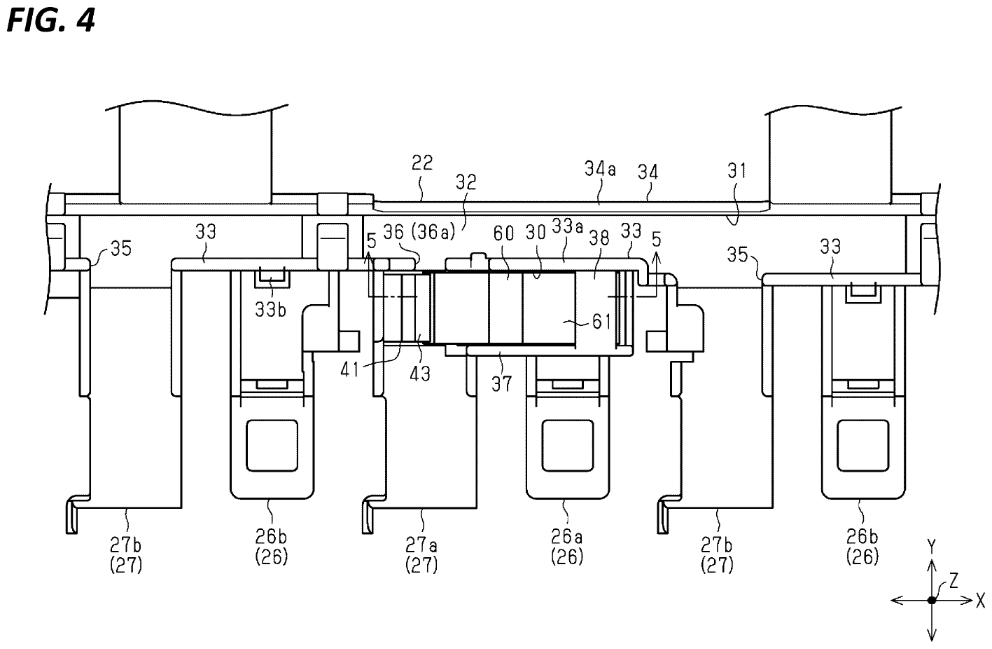

FIGS. 2, 3, and 4 show a region around the sensor housing part 30 in the case 22. As shown in FIG. 4, the case 22 has a wire housing part 31, which extends in the X-direction. Two wire housing parts 31 are provided in correspondence with two rows of the busbars 23 arranged in the X-direction on both sides in the Y-direction of the case 22.

Each wire housing part 31 has a bottom wall 32, and a first side wall 33 and a second side wall 34 that face each other in the Y-direction. The lower face of the bottom wall 32 faces the aforementioned module attachment surface 13 in the Z-direction. The first side wall 33 and the second side wall 34 extend upward from the bottom wall 32. The electric wire 21 is housed in a space between the first side wall 33 and the second side wall 34 that are spaced apart in the Y-direction. Note that the first side wall 33 is a side wall located outward in the Y-direction relative to the second side wall 34. The first busbar holders 26 and the second busbar holders 27 are located outward in the Y-direction of the wire housing part 31.

The upper side of the wire housing part 31, which is open, is covered by the cover 25. Specifically, the first side wall 33 and the second side wall 34 have open ends 33a and 34a, respectively, that are ends on the opposite side to their ends connected to the bottom wall 32. The cover 25 covers the open ends 33a and 34a of the wire housing part 31.

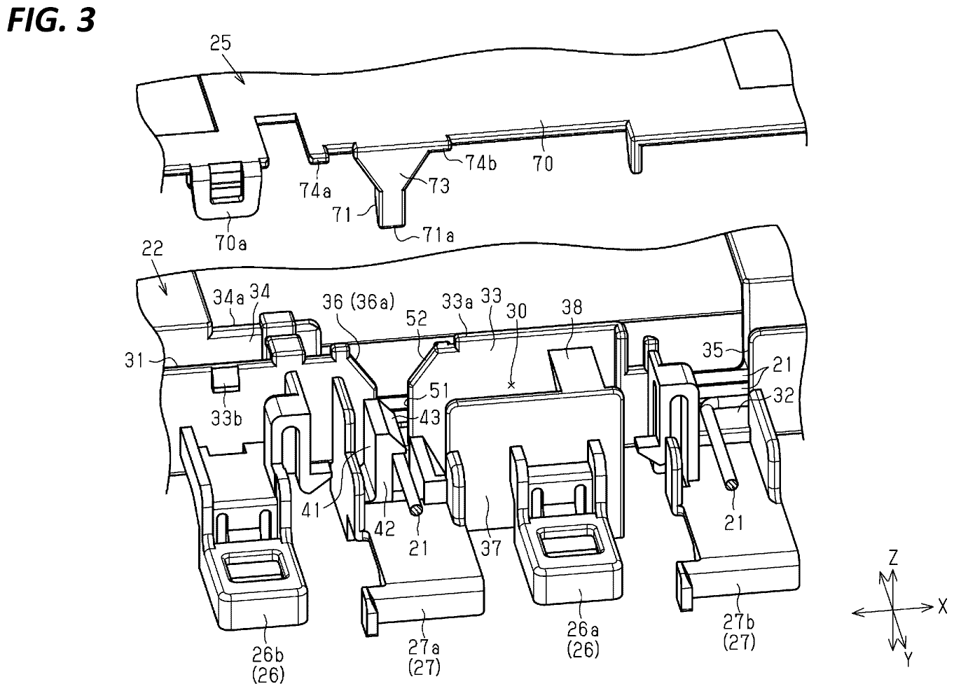

As shown in FIGS. 3 and 4, the sensor housing part 30 spans between one first busbar holder 26 and one second busbar holder 27 that are adjacent to each other in the X-direction. In the following description, the first busbar holder 26 and the second busbar holder 27 between which the sensor housing part 30 spans are referred to as a first busbar holder 26a and a second busbar holder 27a, respectively. The first busbar holders 26 other than the first busbar holder 26a are referred to as first busbar holders 26b. The second busbar holders 27 other than the second busbar holder 27a are referred to as second busbar holders 27b.

The first busbar holders 26b and the second busbar holders 27b extend outward in the Y-direction from the wire housing parts 31. The first side wall 33 of each wire housing part 31 has openings 35 at positions corresponding to the plurality of second busbar holders 27b. One end of each electric wire 21 that is connected to a busbar 23 held by a corresponding second busbar holder 27b is pulled outward in the Y-direction through a corresponding opening 35 from inside the wire housing part 31.

The first busbar holder 26a and the second busbar holder 27a extend outward in the Y-direction from the sensor housing part 30. The first side wall 33 of the wire housing part 31 has a slit 36 at a position corresponding to the second busbar holder 27a. One end of the electric wire 21 that is connected to the busbar 23 held by the second busbar holder 27a is pulled outward in the Y-direction through the slit 36 from inside the wire housing part 31.

The wire housing part 31 has a wire lead-out part 28 (see FIG. 1) at an end in the lengthwise direction. The other end of each electric wire 21 on the opposite side to its end connected to the busbar 23 is collectively led out from the wire lead-out part 28 to outside the case 22 and connected to the connector 24.

### (Configuration of Sensor Housing Part 30)

As shown in FIGS. 2 and 4, the case 22 has an opposing wall 37 that spans between the first busbar holder 26a and the second busbar holder 27a. The opposing wall 37 is located outward in the Y-direction of the first side wall 33 of the wire housing part 31. The opposing wall 37 is, for example, parallel with the first side wall 33. The opposing wall 37 faces the first side wall 33 in the Y-direction. The first busbar holder 26a extends outward in the Y-direction from the opposing wall 37.

The sensor housing part 30 is located between the first side wall 33 and the opposing wall 37. Further, the sensor housing part 30 is located between the first busbar holder 26a and the wire housing part 31. The sensor housing part 30 has a spring support 38. The spring support 38 connects the first side wall 33 and the opposing wall 37.

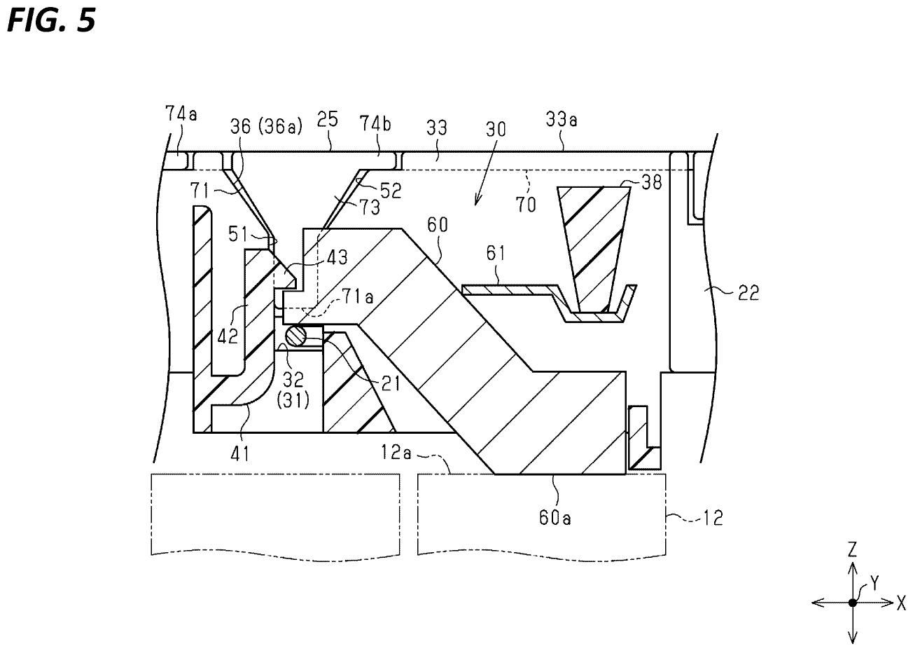

As shown in FIG. 5, the sensor housing part 30 houses the temperature sensor 60 and a spring member 61. The spring member 61 is located between the temperature sensor 60 and the spring support 38. The spring member 61 biases the temperature sensor 60 downward. The temperature sensor 60 is, for example, a thermistor. The temperature sensor 60 has a temperature detection surface 60a. The biasing force of the spring member 61 presses the temperature detection surface 60a of the temperature sensor 60 against an upper surface 12a of a battery cell 12.

As shown in FIGS. 2 and 5, the sensor housing part 30 has a holding piece 41 that holds the temperature sensor 60. The holding piece 41 is located outward in the Y-direction of the wire housing part 31. The holding piece 41 has an extension 42, which extends upward in the Z-direction from a base end of the second busbar holder 27a, and a claw 43, which protrudes from a leading end of the extension 42 along the X-direction. The extension 42 is bendable in the X-direction. The temperature sensor 60 is hooked on the upper side in the Z-direction of the claw 43. Thus, the claw 43 restricts upward displacement in the Z-direction of the temperature sensor 60. The claw 43 of the holding piece 41 is located at a position facing the slit 36 in the opening direction thereof. Note that the opening direction of the slit 36 is parallel with the Y-direction. That is, the claw 43 of the holding piece 41 faces the slit 36 in the Y-direction.

### (Configuration of Slit 36)

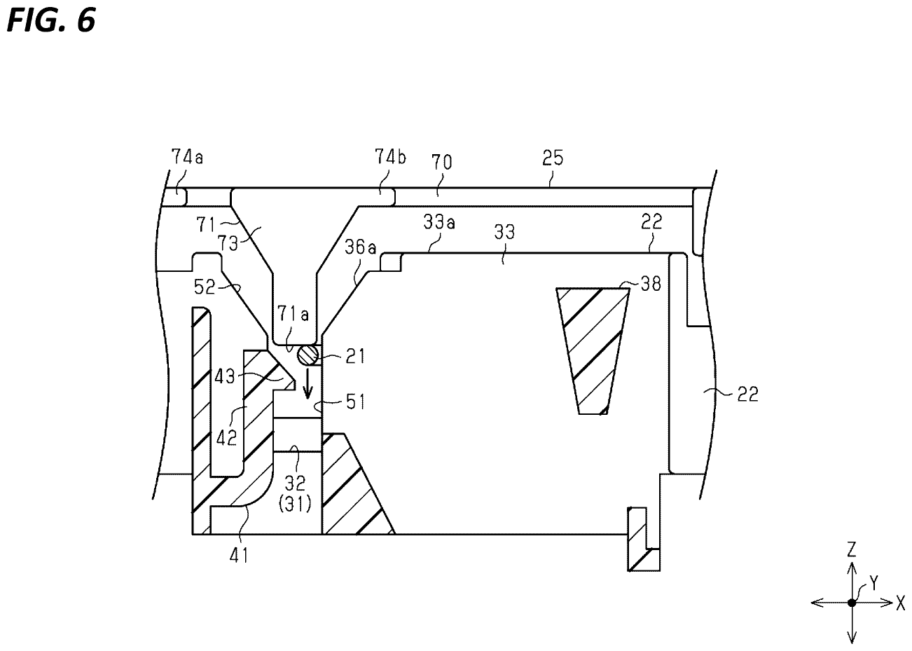

As shown in FIGS. 3 and 6, the slit 36 has a straight part 51 and an inclined part 52. The straight part 51 is formed in the first side wall 33 from an intermediate portion in the Z-direction of the slit 36 to a lower end connected to the bottom wall 32. The inclined part 52 is formed in the first side wall 33 from an upper end of the straight part 51 to the open end 33a. That is, in the present embodiment, the straight part 51 is formed substantially in the lower half of the slit 36, and the inclined part 52 is formed substantially in the upper half of the slit 36. The width in the X-direction of the straight part 51 is uniform in the Z-direction. The inclined part 52 has a shape whose width in the X-direction increases toward the open end 33a. An end surface of the inclined part 52 of the slit 36 has, for example, a straight-line shape.

A plurality of slits 36 are provided in correspondence with the plurality of sensor housing parts 30. The case 22 of the present embodiment has two sensor housing parts 30 and two slits 36. As shown in FIG. 1, of the plurality of (two in the present embodiment) slits 36, the slit 36 closest to the wire lead-out part 28 is referred to as a first slit 36a. Of the plurality of (two in the present embodiment) slits 36, the slit 36 farthest from the wire lead-out part 28 is referred to as a second slit 36b.

### (Configuration of Cover 25)

As shown in FIGS. 2 and 3, the cover 25 is made of an insulating material such as synthetic resin. The cover 25 has a lid 70 that covers the wire housing parts 31. The lid 70 has, for example, a plate shape and is perpendicular to the Z-direction. The upper surface of the lid 70 is configured, for example, to be located at the same position in the Z-direction as the open end 33a of the first side wall 33. Note that the cover 25 has a lock 70a, which extends from the lid 70. The lock 70a is locked at a locking protrusion 33b, which is provided in the first side wall 33. This fixes the cover 25 to the case 22.

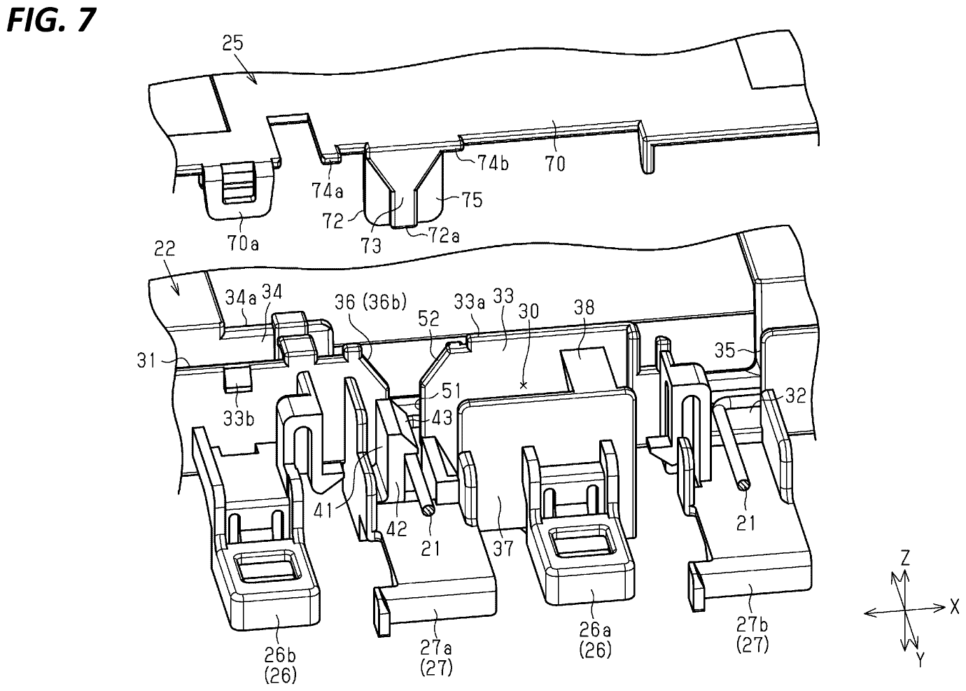

The cover 25 has a first displacement restricting part 71 and a second displacement restricting part 72, which extend along the Z-direction from the lid 70. The first displacement restricting part 71 is provided in correspondence with the first slit 36a (see FIG. 3). The second displacement restricting part 72 is provided in correspondence with the second slit 36b (see FIG. 7).

### (Configuration of First Displacement Restricting Part 71)

As shown in FIGS. 3 and 5, the first displacement restricting part 71 has an insertion part 73, which is inserted into the first slit 36a. The insertion part 73 blocks a portion of the first slit 36a. Specifically, the insertion part 73 blocks the area from the upper end of the inclined part 52 to an intermediate portion in the Z-direction of the straight part 51 in the first slit 36a. Note that the insertion part 73 has a shape following the shape of the inclined part 52 and the straight part 51 as viewed from the opening direction of the first slit 36a, i.e., the Y-direction. That is, the insertion part 73 has a shape that tapers toward its lower end, following the shape of the first slit 36a.

As shown in FIG. 5, the first displacement restricting part 71 has a leading end 71a in its extension direction. The leading end 71a of the first displacement restricting part 71 coincides with a lower end of the insertion part 73. In the first slit 36a, the electric wire 21 is led out to the outside of the wire housing part 31 through a gap formed between the leading end 71a of the first displacement restricting part 71 and the bottom wall 32. When the cover 25 is in a state fitted to the case 22, the leading end 71a of the first displacement restricting part 71 as viewed from the Y-direction is located at a position farther from the lid 70 than the claw 43 of the holding piece 41. That is, the leading end 71a is located downward in the Z-direction of the claw 43 as viewed from the Y-direction.

The cover 25 has a first abutting part 74a and a second abutting part 74b. The first abutting part 74a and the second abutting part 74b are located on respective sides in the X-direction of the first displacement restricting part 71. In other words, the first displacement restricting part 71 is located between the first abutting part 74a and the second abutting part 74b in the X-direction. The first abutting part 74a and the second abutting part 74b abut against the open end 33a of the first side wall 33. Note that the position in the Z-direction of the open end 33a is lowered by the thickness in the Z-direction of the lid 70 at the points where it abuts against the first abutting part 74a and the second abutting part 74b.

### (Configuration of Second Displacement Restricting Part 72)

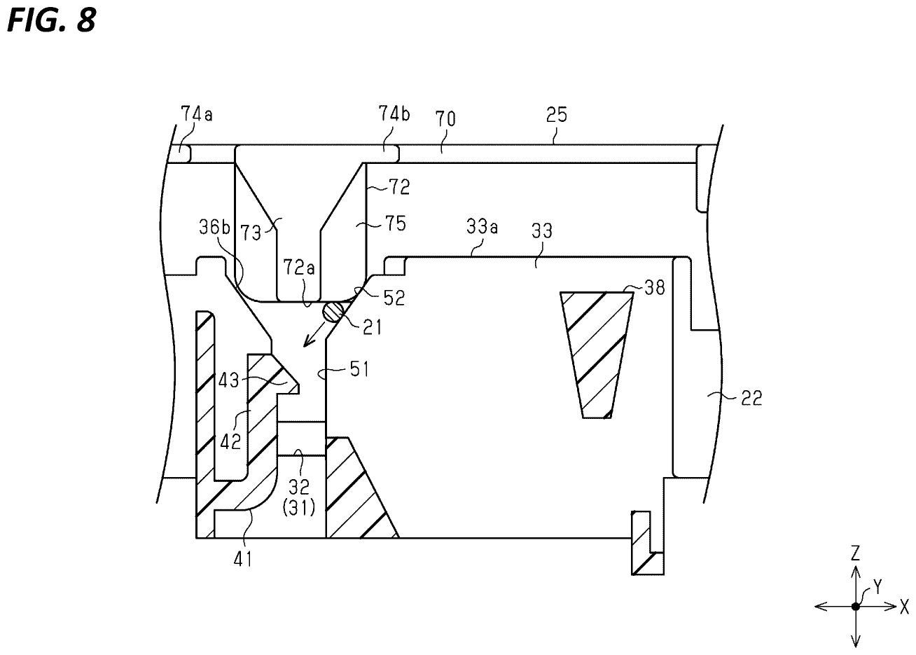

As shown in FIGS. 7 and 8, the second displacement restricting part 72 has an insertion part 73, which is the same as that of the first displacement restricting part 71, and an inner wall 75. The insertion part 73 of the second displacement restricting part 72 is inserted into the second slit 36b. The configuration, including the shape, of the insertion part 73 of the second displacement restricting part 72 is the same as the insertion part 73 of the first displacement restricting part 71, and the detailed description thereof is omitted accordingly.

The inner wall 75 extends from the insertion part 73 on both sides in the X-direction of the insertion part 73. The inner wall 75 is integrated with the insertion part 73. The insertion part 73 of the second displacement restricting part 72 protrudes in the Y-direction from the inner wall 75. Further, in the second displacement restricting part 72, the lower end position of the insertion part 73 coincides with the lower end position of the inner wall 75.

When the cover 25 is in a state fitted to the case 22, the inner wall 75 is located on the inner side of the wire housing part 31. The width in the X-direction of the inner wall 75 is larger than the width of the straight part 51 of the second slit 36b. Thus, the inner wall 75 is disposed at a position overlapping the inclined part 52 as viewed from the opening direction of the second slit 36b, i.e., the Y-direction.

The second displacement restricting part 72 has a leading end 72a in the extension direction that has the same configuration as the leading end 71a of the first displacement restricting part 71. That is, in the second slit 36b, the electric wire 21 is led out to the outside of the wire housing part 31 through a gap formed between the leading end 72a of the second displacement restricting part 72 and the bottom wall 32. When the cover 25 is in a state fitted to the case 22, the leading end 72a of the second displacement restricting part 72 as viewed from the Y-direction is located at a position farther from the lid 70 than the claw 43 of the holding piece 41. That is, the leading end 72a is located downward in the Z-direction of the claw 43 as viewed from the Y-direction.

Note that the aforementioned first abutting part 74a and second abutting part 74b are also provided on respective sides in the X-direction of the second displacement restricting part 72. That is, the second displacement restricting part 72 is located between the first abutting part 74a and the second abutting part 74b in the X-direction.

Next, a mode of fitting each electric wire 21, the cover 25, and the temperature sensor 60 in the battery wiring module 10 is described.

When a plurality of electric wires 21 are arranged in the case 22, they are fitted in order starting from an electric wire 21 connected to the busbar 23 close to the wire lead-out part 28. Therefore, electric wires 21 connected to busbars 23 closer to the wire lead-out part 28 pass closer to the bottom wall 32 of the wire housing part 31. Electric wires 21 that are connected to busbars 23 farther from the wire lead-out part 28 are arranged above the electric wires 21 arranged earlier.

The cover 25 is fitted to the case 22 after arranging the electric wires 21 in the case 22.

Here, FIG. 6 shows how the first displacement restricting part 71 is inserted into the first slit 36a when the cover 25 is fitted. There are cases where the electric wire 21 passed through the first slit 36a rises in the direction away from the bottom wall 32 and is positioned above the claw 43 of the holding piece 41, as shown in FIG. 6. In this case, when the first displacement restricting part 71 is inserted into the first slit 36a downward in the Z-direction, the leading end 71a of the first displacement restricting part 71 comes into contact with the electric wire 21 and moves the electric wire 21 downward of the claw 43.

If the temperature sensor 60 is fitted with the electric wire 21 positioned above the claw 43, there is a concern that the electric wire 21 will be sandwiched by the claw 43 and the temperature sensor 60. In this regard, the first displacement restricting part 71 of the present embodiment restrains the electric wire 21 from moving upward of the claw 43. This prevents the electric wire 21 from being sandwiched by the claw 43 and the temperature sensor 60.

Note that the first slit 36a is located closer to the wire lead-out part 28 than the second slit 36b. Thus, in the wire housing part 31, another electric wire 21 is disposed above the electric wire 21 that is passed through the first slit 36a. This makes it unlikely for the electric wire 21 passed through the first slit 36a to rise in the direction away from the bottom wall 32.

Meanwhile, the second slit 36b is located at a position farther from the wire lead-out part 28 than the first slit 36a. Thus, the electric wire 21 that is passed through the second slit 36b is disposed above another electric wire 21 in the wire housing part 31. This makes it likely for the electric wire 21 passed through the second slit 36b to rise in the direction away from the bottom wall 32.

FIG. 8 shows how the second displacement restricting part 72 is inserted into the second slit 36b when the cover 25 is fitted. As shown in FIG. 8, there are cases where the electric wire 21 passed through the second slit 36b rises to the inclined part 52 of the second slit 36b. In this case, when the second displacement restricting part 72 is inserted downward in the Z-direction, the lower end of the inner wall 75 of the second displacement restricting part 72 comes into contact with the electric wire 21 and moves the electric wire 21 downward. At this time, the electric wire 21 pushed downward by the inner wall 75 moves downward along the inclined part 52 of the second slit 36b and enters the straight part 51. Thereafter, the electric wire 21 is pushed downward of the claw 43 by the leading end 72a of the second displacement restricting part 72.

Here, consider the case where the second displacement restricting part 72 does not have the inner wall 75. In this case, there is a concern that when the electric wire 21 has risen up to the inclined part 52, even if the insertion part 73 is inserted into the second slit 36b, the electric wire 21 will be unable to be brought into contact with the lower end of the insertion part 73, and the electric wire 21 will be sandwiched between the inclined part 52 and the second displacement restricting part 72. In this regard, in the present embodiment, the second displacement restricting part 72 has the inner wall 75 that guides the electric wire 21 that is present at the inclined part 52 to the straight part 51. This makes it possible to prevent the electric wire 21 from being sandwiched by the inclined part 52 and the second displacement restricting part 72.

Note that the first displacement restricting part 71 that corresponds to the first slit 36a does not have the inner wall 75. As mentioned above, the electric wire 21 passed through the first slit 36a is unlikely to rise in the direction away from the bottom wall 32, so that the electric wire 21 is unlikely to rise to the inclined part 52 of the first slit 36a. Therefore, the inner wall 75 is omitted from the first displacement restricting part 71 to secure space within the wire housing part 31.

Effects of the present embodiment are described.

(1) The cover 25 has a first displacement restricting part 71 and a second displacement restricting part 72, which extend from the lid 70. The first displacement restricting part 71 and the second displacement restricting part 72 restrict the displacement of the electric wires 21 in the direction approaching the lid 70. According to this configuration, the first displacement restricting part 71 and the second displacement restricting part 72 restrict the positions of the electric wires 21, thereby making it possible to suppress interference between the electric wires 21 and the temperature sensor 60, for example.

(2) The wire housing part 31 has slits 36 from which the electric wires 21 are led out. The first displacement restricting part 71 and the second displacement restricting part 72 each block a portion of the corresponding slit 36. According to this configuration, the first displacement restricting part 71 and the second displacement restricting part 72 can restrict the positions of the electric wires 21 near the slits 36 from which the electric wires 21 are led out.

(3) The case 22 has a claw 43 serving as an engagement part that engages with the temperature sensor 60 that is attached to the case 22. The claw 43 is located at a position facing a slit 36, outside the wire housing part 31. As viewed from the Y-direction, which is the direction in which the claw 43 and the slit 36 face each other, the leading ends 71a and 72a of the first displacement restricting part 71 and the second displacement restricting part 72 are located at positions farther from the lid 70 than the claw 43. According to this configuration, the leading ends 71a and 72a of the first displacement restricting part 71 and the second displacement restricting part 72 can restrict the positions of the electric wires 21 to positions farther from the lid 70 than the claw 43. This can suppress interference between the electric wires 21 and the temperature sensor 60 that engages with the claw 43.

(4) Each wire housing part 31 has a bottom wall 32, and a first side wall 33 and a second side wall 34 that extend from the bottom wall 32 and face each other. The lid 70 covers the open ends 33a and 34a side of the wire housing parts 31. Each slit 36 extends from the open end 33a to the end connected to the bottom wall 32 in the first side wall 33. According to this configuration, the first displacement restricting part 71 and the second displacement restricting part 72 can restrict the positions of the electric wires 21 near the slits 36 provided in the first side wall 33 of the wire housing part 31.

(5) The cover 25 has a first abutting part 74a and a second abutting part 74b that abut the open end 33a of the first side wall 33. According to this configuration, the first abutting part 74a and the second abutting part 74b abut against the open end 33a of the first side wall 33, thereby preventing the cover 25 from further approaching the bottom wall 32. This can prevent the cover 25 from being pushed to the bottom wall 32 side and the electric wires 21 from being sandwiched by the first displacement restricting part 71, the second displacement restricting part 72, and the bottom wall 32.

(6) The first abutting part 74a and the second abutting part 74b are located on the respective sides in the X-direction of the first displacement restricting part 71. With this, the first abutting part 74a and the second abutting part 74b abut against the open end 33a of the first side wall 33 on the respective sides of the first displacement restricting part 71. Further, the first abutting part 74a and the second abutting part 74b are located on the respective sides in the X-direction of the second displacement restricting part 72. With this, the first abutting part 74a and the second abutting part 74b abut against the open end 33a of the first side wall 33 on the respective sides of the second displacement restricting part 72. Accordingly, the first abutting part 74a and the second abutting part 74b can preferably prevent the cover 25 from being pushed to make the first displacement restricting part 71 and the second displacement restricting part 72 approach the bottom wall 32.

(7) The first displacement restricting part 71 has an insertion part 73, which is inserted into the first slit 36a. According to this configuration, the first displacement restricting part 71, including the insertion part 73, can be configured so as not to be located within the wire housing part 31. This can contribute to securing space within the wire housing part 31.

(8) Each slit 36 has an inclined part 52 whose width increases toward the open end 33a of the first side wall 33. According to this configuration, the inclined part 52 allows the electric wires 21 to be easily placed into the slit 36. As a result, the fittability of the electric wires 21 to the case 22 can be improved.

(9) The second displacement restricting part 72 has an inner wall 75, which is located on the inner side of the wire housing part 31. The inner wall 75 is disposed at a position overlapping the inclined part 52 as viewed from the direction in which the first side wall 33 and the second side wall 34 face each other, i.e., the Y-direction. According to this configuration, the inner wall 75 can prevent the electric wire 21 from being sandwiched by the inclined part 52 and the second displacement restricting part 72.

(10) A plurality of slits 36, each of which has an inclined part 52, are provided in the case 22 along the lengthwise direction of the wire housing parts 31. The wire housing parts 31 have a wire lead-out part 28 at an end in the lengthwise direction. One end of each electric wire 21 is individually lead out from a corresponding one of the slits 36. The other end of each electric wire 21 is collectively led out from the wire lead-out part 28. According to this configuration, a plurality of slits 36 corresponding to the respective electric wires 21 each have an inclined part 52. This can improve the fittability of the electric wires 21.

(11) The first displacement restricting part 71 is provided in correspondence with the first slit 36a, which is closest to the wire lead-out part 28 among the plurality of slits 36. Further, the first displacement restricting part 71 has an insertion part 73, which is inserted into the first slit 36a, but does not have an inner wall 75 such as that of the second displacement restricting part 72. The electric wire 21 that is led out from the first slit 36a is disposed near the bottom wall 32 of the wire housing part 31, so that this electric wire 21 is less likely to rise in the direction away from the bottom wall 32. Accordingly, it is less likely for the electric wire 21 to be sandwiched by the inclined part 52 and the first displacement restricting part 71 in the first slit 36a, so that the inner wall 75 can be omitted from the first displacement restricting part 71, which contributes to securing space within the wire housing part 31.

(12) The second displacement restricting part 72 is provided in correspondence with the second slit 36b, which is farthest from the wire lead-out part 28 among the plurality of slits 36. The electric wire 21 that is led out from the second slit 36b is likely to rise in the direction away from the bottom wall 32. The electric wire 21 is therefore likely to rise to the position of the inclined part 52 in the second slit 36b. Since the second displacement restricting part 72 corresponding to the second slit 36b has the inner wall 75, the inner wall 75 can effectively prevent the electric wire 21 from being sandwiched by the inclined part 52 and the second displacement restricting part 72.

### (Modifications)

The present embodiment can be modified as follows when implemented. The present embodiment and the following modifications can be implemented in combination as long as no technical contradiction arises.
In the above embodiment, the second displacement restricting part 72 may be changed to the first displacement restricting part 71.
In the above embodiment, the first displacement restricting part 71 may be changed to the second displacement restricting part 72. That is, all of the displacement restricting parts provided in correspondence with the respective slits 36 may be changed to the second displacement restricting parts 72 each having the inner wall 75. According to this configuration, in each slit 36, the inner wall 75 can prevent the electric wire 21 from being sandwiched by the inclined part 52 and the second displacement restricting part 72.
In the above embodiment, the number of sensor housing parts 30 and the number of slits 36 corresponding thereto is two, but there is no limitation thereto. The number of sensor housing parts 30 and the number of slits 36 may be one, or three or more.
The shape of the second displacement restricting part 72 is not limited to the above embodiment. For example, the insertion part 73 may be omitted from the second displacement restricting part 72 of the above embodiment, and the second displacement restricting part 72 may be formed only with a plate-shaped inner wall 75. Further, the first displacement restricting part 71 may also be formed only with a plate-shaped inner wall 75.
The first displacement restricting part 71 and the second displacement restricting part 72 of the above embodiment are each located at a position blocking a portion of a corresponding slit 36. However, in another example, the first displacement restricting part 71 and the second displacement restricting part 72 may each be located at a position not blocking a slit 36 within the wire housing part 31. Further, a displacement restricting part that extends from the lid 70 and restricts the displacement of the electric wire 21 in the direction approaching the lid 70 may be provided at a position corresponding to an opening 35.
In the above embodiment, the temperature sensor 60 is taken as an example of the electrical component that is attached to the case 22 and engaged with the claw 43, but the electrical component may be a component other than the temperature sensor 60.
In the above embodiment, either the first abutting part 74a or the second abutting part 74b may be omitted. That is, an abutting part that abuts against the open end 33a of the first side wall 33 may be provided on only one side in the X-direction of at least either the first displacement restricting part 71 or the second displacement restricting part 72.
The shape of an end surface of the slit 36 in the inclined part 52 as viewed from the Y direction may be changed to, for example, a curved shape.
An alternative configuration may be employed in which the inclined part 52 is omitted from each slit 36, and the slit 36 only has the straight part 51.
The sensor housing part 30 of the above embodiment spans between the first busbar holder 26a and the second busbar holder 27a, but the position at which the sensor housing part 30 is disposed in the case 22 is not specifically limited to the above embodiment.
The cover 25 may be integrated with the case 22.
The embodiment and the modifications disclosed herein are illustrative in all respects, and should not be considered restrictive. That is, the scope of the present invention is defined by the claims, and is intended to encompass all modifications within the meaning and scope equivalent to the claims.

### LIST OF REFERENCE NUMERALS

10 Battery wiring module
11 Battery
12 Battery cell
12a Upper surface
13 Module attachment surface
14 Battery terminal
21 Electric wire
22 Case
23 Busbar
24 Connector
25 Cover
26 (26a, 26b) First busbar holder
27 (27a, 27b) Second busbar holder
28 Wire lead-out part
30 Sensor housing part
31 Wire housing part
32 Bottom wall
33 First side wall
33a Open end
33b Locking protrusion
34 Second side wall
34a Open end
35 Opening
36 Slit
36a First slit (slit)
36b Second slit (slit)
37 Opposing wall
38 Spring support
41 Holding piece
42 Extension
43 Claw (engagement part)
51 Straight part
52 Inclined part
60 Temperature sensor (electrical component)
60a Temperature detection surface
61 Spring member
70 Lid
70a Lock
71 First displacement restricting part (displacement restricting part)
71a Leading end
72 Second displacement restricting part (displacement restricting part)
72a Leading end
73 Insertion part
74a First abutting part (abutting part)
74b Second abutting part (abutting part)
75 Inner wall
X Direction
Y Direction (the direction in which the engagement part and the slit face each other; the direction in which the first side wall and the second side wall face each other)
Z Direction

1. A battery wiring module that is attachable to a battery, the battery wiring module comprising:
an electric wire to be electrically connected to the battery;
a case having a wire housing part housing the electric wire; and
a cover having a lid covering the wire housing part,
wherein the cover has a displacement restricting part extending from the lid, and
the displacement restricting part restricts displacement of the electric wire in a direction approaching the lid.

2. The battery wiring module according to claim 1, wherein the wire housing part has a slit from which the electric wire is led out, and the displacement restricting part is configured to block a portion of the slit.

3. The battery wiring module according to claim 2, wherein the case has an engagement part to be engaged with an electrical component to be attached to the case,
the engagement part is located outward of the wire housing part at a position corresponding to the slit, and
as viewed in a direction in which the engagement part and the slit face each other, a leading end of the displacement restricting part is located at a position farther from the lid than the engagement part.

4. The battery wiring module according to claim 2,
wherein the wire housing part has: a bottom wall; and a first side wall and a second side wall that extend from the bottom wall and face each other,
the first side wall and the second side wall each have an open end that is an end on an opposite side to the bottom wall, and the lid covers the open end side of the wire housing part, and
the slit extends from the open end to an end connected to the bottom wall in the first side wall.

5. The battery wiring module according to claim 4,
wherein the cover has an abutting part abutting against the open end of the first side wall.

6. The battery wiring module according to claim 5,
wherein the abutting part includes a first abutting part and a second abutting part that are located on respective sides of the displacement restricting part.

7. The battery wiring module according to claim 4,
wherein the displacement restricting part has an insertion part inserted into the slit.

8. The battery wiring module according to claim 4,
wherein the slit has an inclined part whose width increases toward the open end of the first side wall.

9. The battery wiring module according to claim 8,
wherein the displacement restricting part has an inner wall located on an inner side of the wire housing part, and
the inner wall is located at a position overlapping the inclined part as viewed from a direction in which the first side wall and the second side wall face each other.

10. The battery wiring module according to claim 8,
wherein the slit having the inclined part is one of a plurality of slits provided in the case and arranged along a lengthwise direction of the wire housing part,
the displacement restricting part is one of a plurality of displacement restricting parts provided in the cover in correspondence with the respective slits,
the wire housing part has a wire lead-out part at an end in the lengthwise direction,
the electric wire is one of a plurality of electric wires,
one end of each of the plurality of electric wires is individually led out from a corresponding one of the plurality of slits, and
another end of each of the electric wires is collectively led out from the wire lead-out part.

11. The battery wiring module according to claim 10,
wherein the plurality of displacement restricting parts include a first displacement restricting part and a second displacement restricting part,
the first displacement restricting part has an insertion part inserted into a corresponding one of the plurality of slits,
the second displacement restricting part has an inner wall located on an inner side of the wire housing part,
the inner wall is located at a position overlapping the inclined part as viewed from a direction in which the first side wall and the second side wall face each other,
the first displacement restricting part does not have the inner wall, and
the first displacement restricting part is provided in correspondence with a slit closest to the wire lead-out part among the plurality of slits.

12. The battery wiring module according to claim 11,
wherein the second displacement restricting part is provided in correspondence with a slit farthest from the wire lead-out part among the plurality of slits.

13. The battery wiring module according to claim 10,
wherein the plurality of displacement restricting parts each have an inner wall located on an inner side of the wire housing part, and
the inner wall is located at a position overlapping the inclined part as viewed from a direction in which the first side wall and the second side wall face each other.
